(19) United States
(12) Patent Application Publication
(10) Pub. No.: US 2017/0163077 A1
(43) Pub. Date: Jun. 8, 2017

(54) SOLAR POWERED CELL PHONE CHARGING DEVICE

(71) Applicants: Howard Barrett Lindner, Wellington, FL (US); Ita May Hill, West Palm Beach, FL (US)

(72) Inventors: Howard Barrett Lindner, Wellington, FL (US); Ita May Hill, West Palm Beach, FL (US)

(21) Appl. No.: 15/368,048

(22) Filed: Dec. 2, 2016

Related U.S. Application Data
(60) Provisional application No. 62/262,193, filed on Dec. 2, 2015.

(51) Int. Cl. H02J 7/02; H02J 7/00

(52) U.S. Cl. CPC H02J 7/025; H02J 7/0042

(57) ABSTRACT

A solar powered cell phone charging device has been disclosed that provides a cell phone case with integrated solar panels and a power connector coupled to the case for connecting to a cell phone charging port, allowing the user to charge a cell phone by using solar power. In an increasingly digital age, with further reliance on cell phones for almost every aspect of daily life, there exists a need to be able to portably charge a cell phone. Further, there exists a need to perform this charging through renewable energy sources, rather than non-renewable sources, due to the cost and deletion of non-renewable energy sources. Finally, there exists a need to be able to portably charge cell phones without being tethered to a wall or a portable battery pack, which must be independently charged through traditional non-renewable energy sources.

### CROSS-REFERENCE TO RELATED APPLICATION

This application claims priority to U.S. Provisional Patent Application No. 62/262,193, filed Dec. 2, 2015, the entirety of which is incorporated by reference.

### FIELD OF THE INVENTION

The present invention relates generally to solar powered cell phone charging devices, and, more particularly, relates to a cell phone charging device with integrated solar panels that charges a cell phone by converting photons into usable electrical energy.

### BACKGROUND OF THE INVENTION

In an increasingly digital age, in which humans are becoming even more reliant on their cell phones for almost every aspect of their daily lives, society is faced with a problem—that of efficiently charging cell phones while on-the-go. Since cell phones are used to navigate, listen to music, and draft and respond to emails and text messages, in addition to the traditional telephonic function of verbally communicating with others, cell phone battery usage is reaching new heights. Combined with being forced to charge cell phones through traditional utilities, which are often times derived from non-renewable energy sources, there is a need for a renewable energy source that charges a cell phone.

A traditional portable device for charging a cell phone is that of a portable battery pack. A number of such portable battery packs are included in a cell phone case. These portable battery packs, however, face the same problems as typical methods of charging a cell phone—reliance on traditional utility sources to charge the battery, and the requirement for the user to be proactive, making sure that the battery pack is charged prior to use. If the user fails to ensure that the portable battery pack is charged prior to use, the user may be faced with a situation in which the portable battery pack is rendered completely useless, such as when the user does not have access to a charging port.

### SUMMARY OF THE INVENTION

The invention provides a solar powered cell phone charging device that overcomes many disadvantages of the heretofore-known devices and methods of this general type, and that provides a cell phone case with solar panels integrated therein, and a power connector coupled to the case for connecting a cell phone charging port thereto.

With the foregoing and other objects in view, there is provided, in accordance with the invention, a solar-powered cell phone charging device including at least one solar cell operably configured to collect photons and convert the photons into electrical energy. The solar powered cell phone charging device also includes a case at least partially housing the at least one solar cell, and defining a cell phone receiving area sized and shaped for receiving a cell phone therein, and at least one power connector coupled to the case and the at least one solar cell, the at least one power connector operably sized and shaped to selectively, mechanically, and electrically couple with a mating cell phone power charging port.

Although the invention is illustrated and described herein as embodied in a solar powered cell phone charging case, it is, nevertheless, not intended to be limited to the details shown because various modifications and structural changes may be made therein without departing from the spirit of the invention, and within the scope and range of equivalents of the claim or claims. Additionally, well-known elements of exemplary embodiments of the invention will not be described in detail or will be omitted so as not to obscure the relevant details of the invention.

It is to be understood that the disclosed embodiments described herein and depicted in the figures are merely exemplary of the invention, which can be embodied in various forms. Therefore, specific structural and functional details disclosed herein are not to be interpreted as limiting, but merely as a basis for the claims, and as a representative basis for teaching one of ordinary skill in the art to variously employ the present invention in virtually any appropriately detailed structure. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the case.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational front view of the solar powered cell phone charging case depicting an interior compartment of a back cover of the solar powered cell phone charging case;

FIG. 2 is an elevational front view of the interior back cover of the solar powered cell phone charging case of FIG. 1 in accordance with one embodiment of the present invention;

FIG. 3 is an elevational rear view of the back cover of the solar powered cell phone charging case of FIG. 1 in accordance with one embodiment of the present invention;

FIG. 4 is an elevational left side view of a solar powered cell phone charging case in accordance with an exemplary embodiment of the present invention;

FIG. 5 is an elevational front view of the solar powered cell phone charging case of FIG. 4 in accordance with an exemplary embodiment of the present invention;

FIG. 6 is a cross-sectional side view of the solar powered cell phone charging case along section 5-5 of FIG. 5;

FIG. 7 is an elevational bottom view of the solar powered cell phone charging case along section 7-7 of FIG. 5;

FIG. 8 is a cross-sectional and elevational bottom view of the solar powered cell phone charging case along section 6-6 of FIG. 5;

FIG. 9 is a perspective view of the solar powered cell phone charging case of FIG. 4 depicting the front of the solar powered cell phone charging case in accordance with an exemplary embodiment of the present invention;

FIG. 10 is a perspective front view of the solar powered cell phone charging case of FIG. 4 in accordance with an exemplary embodiment of the present invention;

FIG. 11 is a perspective view of the solar powered cell phone charging case of FIG. 4 depicting the front of the solar powered cell phone charging case in accordance with an exemplary embodiment of the present invention;

FIG. 12 is a perspective front view of the solar powered cell phone charging case in accordance with one embodiment of the present invention;

FIG. 13 is a downward-looking perspective view of the back cover of the solar powered cell phone charging case in accordance with one embodiment of the present invention;

FIG. 14 is a table of component parts of the solar powered cell phone charging case in accordance with one embodiment of the present invention; and

FIG. 15 is an electrical schematic diagram associated with the solar powered cell phone charging case in accordance with one embodiment of the present invention.

### DETAILED DESCRIPTION

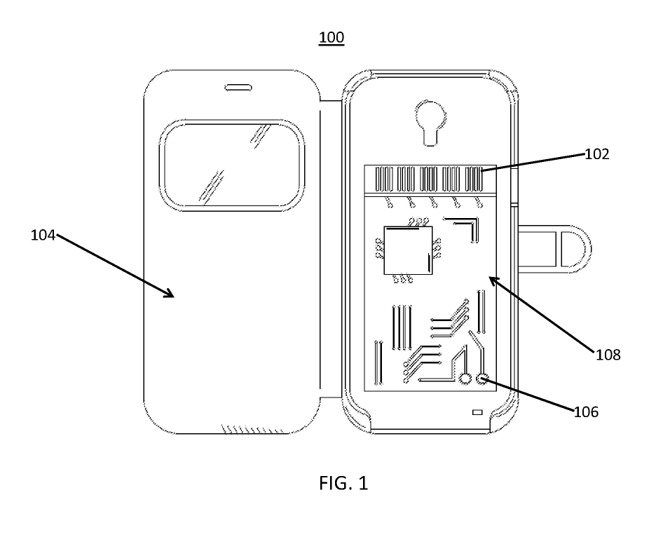

It is to be understood that the disclosed embodiments are merely exemplary of the invention, which can be embodied in various forms. The present invention provides a novel and efficient solar powered cell phone charging case. Referring now to FIGS. 1-3, one embodiment of the present invention is shown in various views. FIGS. 1-3 show several advantageous features of the present invention, but, as will be described below, the invention can be provided in several shapes, sizes, combinations of features and components, and varying numbers and functions of the components. The first example of a solar powered cell phone charging case 100, as shown in FIGS. 1-3, includes a plurality of solar cells 102 housed within a case 104. The term “case” is defined herein in its broadest possible sense as any container for holding a substantial portion, e.g., at least 50%+/−15%, of a cell phone body therein. The solar powered cell phone charging case 100 also includes a power connector 200. The term “connector” is defined herein in its broadest possible sense as the male member of an electrical connection that is typically found on the mating port of a cell phone. The term “cell phone” is defined herein in its broadest possible sense as a smartphone or other type of cellular, portable telephone device that is substantially rectangular in shape, i.e. an iPhone®. As used herein, the term “port” is defined in its broadest possible sense as the mating female member that receives the power connector 200 therein for transmitting power to the cell phone. The power connector 200 is sized and shaped to couple to a cell phone by being inserted within the mating port of the cell phone, such that the power connector 200 forms a substantially connected and secure relationship with the mating port of the cell phone, allowing for the charging of the cell phone's battery.

Advantageously, the case 104 provides a housing 108 for the solar cells 102 to be embedded, coupled with, or otherwise integrated therein. The solar cells 102, as known in art, are operable to receive, collect, and store light, i.e. photons, as solar energy, by being exposed to an amount of light. The term “light” as used herein is defined in its broadest possible sense to include solar energy, as well as ambient light from devices such as light bulbs. This solar energy is then converted by a converter into electrical energy that can be used to charge a cell phone. The electrical energy is transmitted to the cell phone that mates with the solar powered cell phone charging case 100 via the power connector 200. In one embodiment, the power connector 200 is shaped to matingly (mechanically and electrically) couple with a particular type of cell phone charging port. It is often the case that cell phones have a specialized type of charging port that requires a specialized mating power connector. Accordingly, various embodiments of the present invention may be provided with such specialized power connectors 200. For example, iPhones® require an iPhone® connector to charge the iPhone® via the iPhone® charging port defined by the body of the iPhone®.

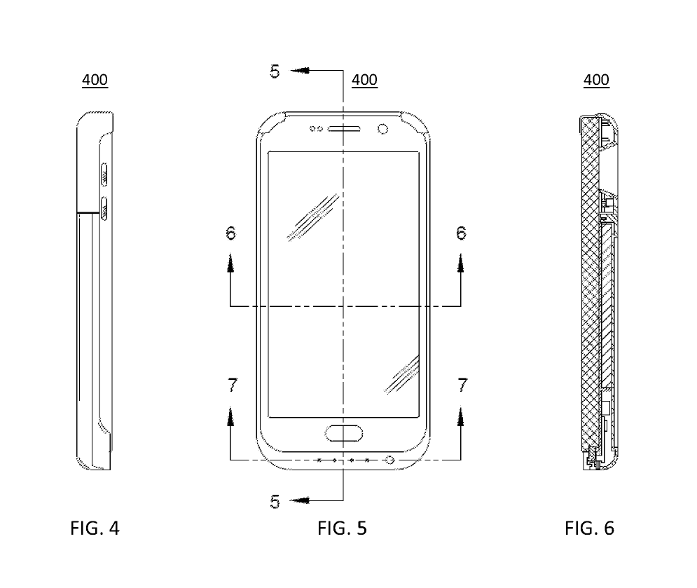

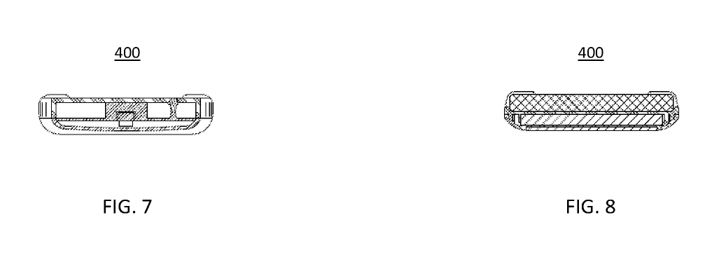

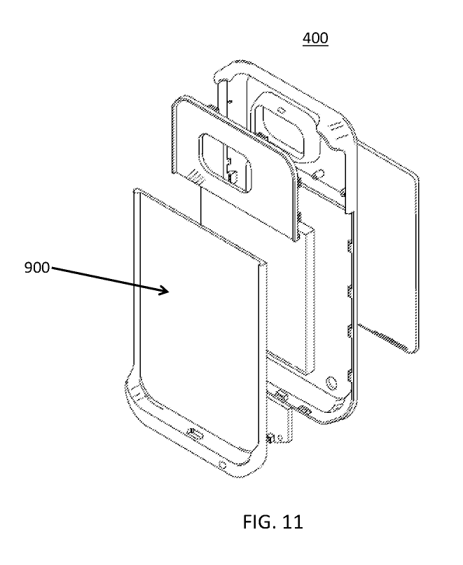

In one embodiment, the case 104 may be provided with a front cover and a back cover as illustrated in the embodiment depicted in FIGS. 1-3. Alternatively, the case 104 may be provided with a single cover, as illustrated in the embodiments depicted in FIGS. 4-12. In one embodiment, the case 104 may be made of a rigid polymer material (e.g., a rigid plastic). In another embodiment, the case 104 may be made of a flexible polymer material. In one embodiment, the case 104 may include decorative indicia or other designs on an outer surface so as to increase the aesthetic appeal.

In one embodiment, the case 104 may be provided with openings so as to allow the user access to portions of the cell phone that is placed within the case 104. In another embodiment, the case 104 may include a clear plastic transparent window so that the user can view one or more of the cell phone display, touchscreen, or keyboard. In a further embodiment, the case 104 may define one or more openings for various ports (audio jack, power, etc.) so that the user may access these ports without opening the cover. The case 104 may define one or more openings for various buttons (e.g., power, image capture, volume control, etc.) so that the user may access the buttons without opening the cover. In addition, the case 104 may define one or more openings for a camera lens or speaker output. Different types and models of cell phones have buttons, camera lenses, speaker outputs, ports, etc. positioned at different areas along the cell phone body. Accordingly, the positioning of the openings, e.g. transparent portions, may be tailored to a particular type and model of cell phone for maximum usefulness to the user.

Referring now to FIGS. 1-3, in one embodiment, at least a portion of the case 104 may be made of a polycarbonate material. For example, a portion of the case 104 may be disposed over the solar cells 102 in order to prevent UV radiation damage from reaching the electrical components, such as the liquid crystal display.

In another embodiment, the case 104 may include one or more red LEDs 106 positioned at a bottom portion of a circuit board on which the electrical components are mounted. The red LEDs 106 may be useful as clamping diodes to limit any voltage generated by the solar cells 102 by converting solar energy into usable electrical energy.

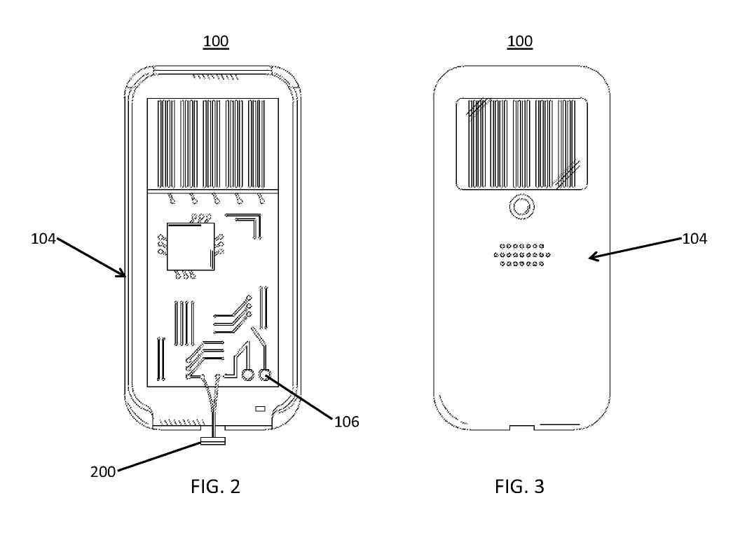

In one embodiment, as illustrated in FIG. 2, a series of solar cells 102 may be provided at a top of the circuit board with a NEC integrated circuit disposed and communicatively coupled below the solar cells 102. In another embodiment, a substantial portion of the circuit board may be populated by an array of contacts that may be used for key board buttons, or other user input devices.

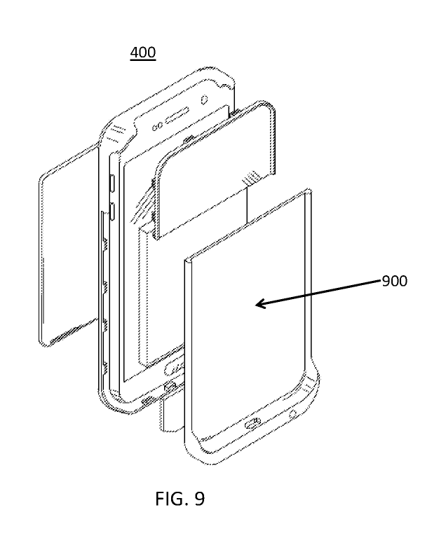

FIGS. 4-12 depict an embodiment of a solar powered cell phone charging case 400 having a body that defines a cell phone receiving area 900 (FIG. 9) with an open face. The solar powered cell phone charging case 400 may include various electrical and solar cell components, similar, but not limited to, the embodiments described above with reference to FIGS. 1-3. The solar powered cell phone charging case 400 may be made of a polycarbonate material, similar to the embodiments described above with reference to FIGS. 1-3. In one non-limiting embodiment, the cover of the solar powered cell phone charging case 400 may be made of a rigid polymer material (e.g., a rigid plastic). In another embodiment, the cover may be made of a flexible polymer material. In one embodiment, a power connector 1200 is formed as a miniUSB connector operably configured to mate with a corresponding miniUSB power port. In other embodiments, the power connector 1200 may be provided in other positions relative to the case and/or may be formed as other types of power connectors known in the art.

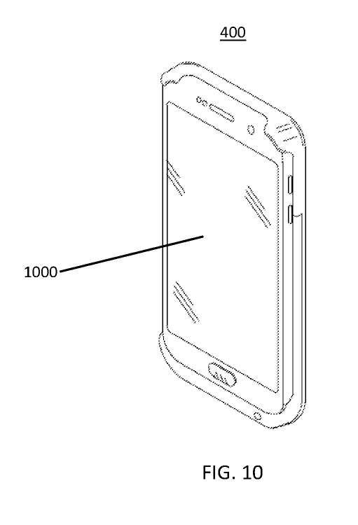

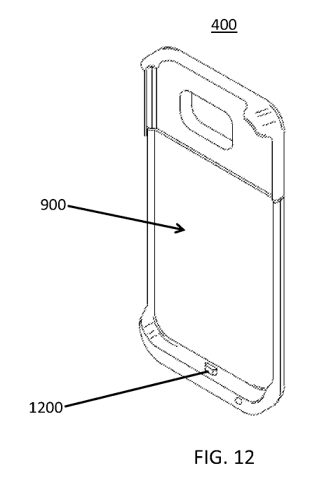

In use, the user may slideably insert a cell phone 1000 (FIG. 10) into a cell phone receiving area 900 (FIG. 9) and couple a power connector 1200 (FIG. 12) with a mating port on the cell phone. Advantageously, the user is not required to have a separate plug and cable to connect to a wall outlet or other power source. Instead, the user may simply expose the case to the light and the case will collect the photons and convert the photons to useable electrical energy. It is beneficial to provide charging devices without an excessive amount of cables which are often cumbersome. By utilizing the device of the present invention, users are able to power their cell phones without the need to plug the cell phone into a wall outlet. In addition, users are not required to purchase a power charging device separate from a cell phone cover/case. Embodiments of the present invention advantageously provide a cell phone case that is also a source of environmentally friendly power. Also, embodiments of the present invention can provide outdoor enthusiasts with a device to charge their cell phones because such users no longer need to be tethered to an electrical source other than solar energy.

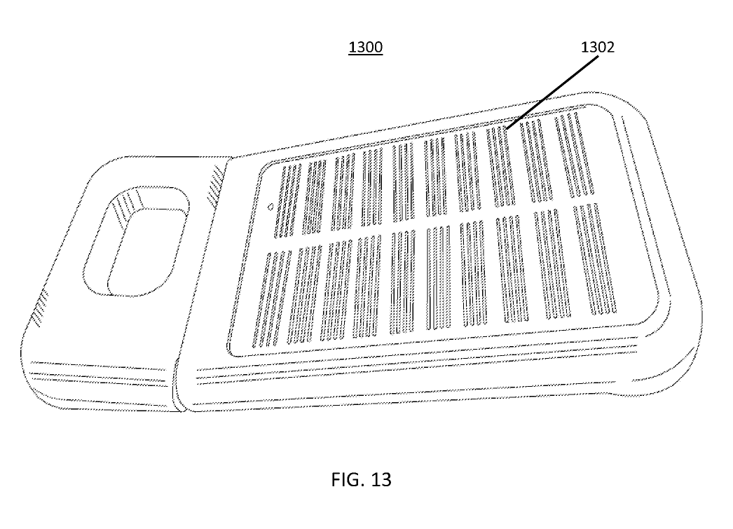

With reference now to FIG. 13, a solar powered cell phone charging case 1300 is depicted having a body that is sized and shaped to receive a cell phone, specifically, substantially rectangular in shape in accordance with a smartphone, such as an iPhone®. The body of the solar powered cell phone charging case 1300 may be of the same size on the top end and the bottom end of the solar powered cell phone charging case 1300, i.e., of consistent dimensions. In one exemplary embodiment, the solar powered cell phone charging case 1300 may include solar cells 1302. In one embodiment, the body of the solar powered cell phone charging case 1300 may be larger at the bottom portion than it is at the top portion. For example, the difference in dimensions may be a result of the solar cells 1302 and the size of the battery of the cell phone that the solar cells 1302 charges.

The solar powered cell phone charging case 1300 may include various electrical and solar cell components, similar to the embodiments described above with reference to FIGS. 1-3. The solar powered cell phone charging case 1300 may be made of a polycarbonate material, similar, but not limited to, the embodiments described above with reference to FIGS. 1-3. The cover of the solar powered cell phone charging case 1300 may be made of a rigid polymer material (e.g., a rigid plastic). In another embodiment, the cover may be made of a flexible polymer material.

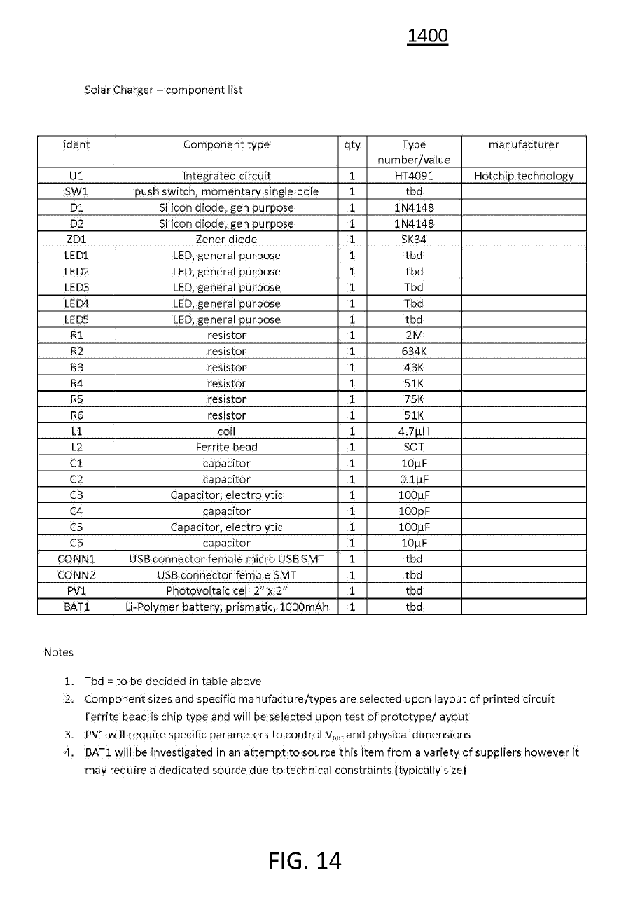

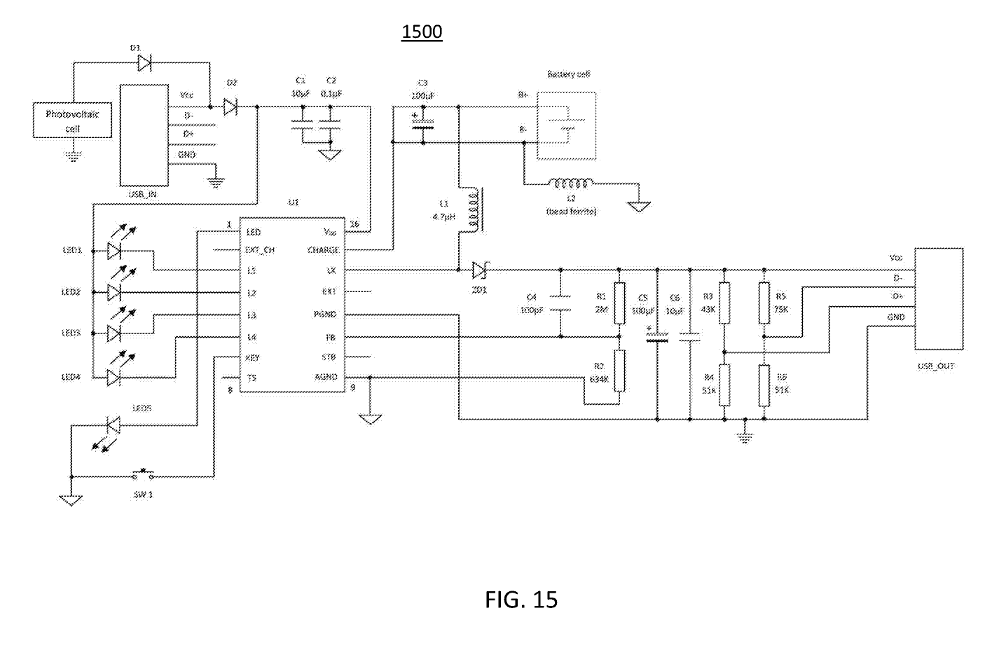

Referring now to FIGS. 14-15, in one embodiment, the solar powered cell phone charging case 100 (FIG. 1) may include component parts 1400. In another embodiment, the solar powered cell phone charging case 100 may include an integrated electrical schematic 1500. Component parts 1400 and integrated electrical schematic 1500 may also be included in embodiments of the solar powered cell phone charging case 400 (FIG. 4) and the solar powered cell phone charging case 1300 (FIG. 13).

A solar powered cell phone charging device has been disclosed that provides a cell phone case with solar panels integrated therein and a power connector coupled to the case for connecting a cell phone charging port thereto, allowing the user to charge a cell phone by using solar power.

What is claimed is:

1. A solar-powered cell phone charging device comprising:
at least one solar cell operably configured to collect photons and convert photons into electrical energy;
a case at least partially housing the at least one solar cell and defining a cell phone receiving area sized and shaped for receiving a cell phone therein; and
at least one power connector coupled to the case and the at least one solar cell, the at least one power connector operably sized and shaped to selectively, mechanically and electrically, couple with a mating cell phone power charging port.
